(19) United States
(12) Patent Application Publication
(10) Pub. No.: US 2026/0287469 A1
(43) Pub. Date: Sep. 24, 2026

(54) METHOD FOR DETECTING A FAULTY MEASUREMENT CHANNEL IN A STRAIN WAVE GEARING MECHANISM

(71) Applicant: Schaeffler Technologies AG & Co. KG, Herzogenaurach (DE)

(72) Inventor: Kazuaki Kaneko, Yokohama (JP)

(21) Appl. No.: 19/472,977

(22) PCT Filed: Mar. 1, 2024
(86) PCT No.: PCT/DE2024/100167

§ 371 Date: Oct. 6, 2025

(30) Foreign Application Priority Data
Apr. 6, 2023 (DE) 10 2023 108 814.9

(51) Int. Cl. G01M 13/021; F16H 49/00

(52) U.S. Cl. CPC G01M 13/021; F16H 49/001; F16H 2049/003

(57) ABSTRACT

A method for detecting a faulty measurement channel on an elastic transmission element in a strain wave gearing mechanism is disclosed. A wave generator acts on the elastic transmission element, and the elastic transmission element has a first strain gauge assembly with a first measurement channel. A first measurement signal of the first measurement channel is proportional to the torque, and the elastic transmission element has a second strain gauge assembly with multiple second measurement channels, second measurement signals of the individual second measurement channels of the second strain gauge assembly being based on the rotational position of the wave generator. For each measurement channel of the second measurement channels, a plausibility check is carried out using the first measurement signal and one or more of the second measurement signals.

### CROSS-REFERENCE TO RELATED APPLICATION

The present application is the U.S. National Phase of PCT Patent Application Number PCT/DE2024/100167, filed on Mar. 1, 2024, which claims priority to German Patent Application Number 10 2023 108 814.9, filed Apr. 6, 2023, the entire disclosures of which are incorporated by reference herein.

### TECHNICAL FIELD

The disclosure relates to a method for detecting a faulty measurement channel on an elastic transmission element in a strain wave gearing mechanism. Furthermore, the disclosure relates to a drive module having a strain wave gearing.

### BACKGROUND

Strain wave gearing mechanisms (also known as harmonic drives) enable almost play-free power transmission with a high transmission ratio, and are therefore particularly suitable for applications that require precise movements and a small space requirement. Since high torques can be generated with relatively small motors due to the high transmission ratio, strain wave gearing mechanisms can be used to create very compact drive mechanisms that are used, for example, in robotics.

The main components of a strain wave gearing mechanism are a wave generator, a rigid outer ring (“circular spline”) with an inner toothing and an elastic transmission element (“flexspline”) with an outer toothing arranged therebetween. As opposed to rigid gearing mechanisms, the transmission of torque between the wave generator and the outer ring is based on elastic deformation, in which the transmission ring is deformed into an oval by the wave generator in such a way that it engages with the outer ring on two opposite sides of its circumference. As the wave generator rotates, the transmission ring rolls on the outer ring, such that a torque is transmitted between the transmission ring and the outer ring by means of the meshing toothing systems. Thus, the transmission ratio of the gearing mechanism is determined by the difference in the number of teeth on the transmission ring and the outer ring.

During operation, excessive torque, for example when the gearing mechanism is working against high resistance, causes engagement faults. An engagement fault is an at least partial loss of engagement between the transmission ring and the outer ring, such that the teeth of the transmission ring skip over (“ratcheting”) the teeth of the outer ring. While the rotation of the transmission ring and that of the outer ring are strictly coupled during normal operation, such an engagement fault temporarily leads to an uncontrolled relative rotation between the two rings. This creates an unknown angular offset on the output side relative to the drive side, which makes precise checking of the angular position impossible.

Torque sensors in the strain wave gearing mechanism can provide information about the condition of the strain wave gearing mechanism during operation and can be used to monitor its operation. For this purpose, the torque sensors are designed as strain gauges and arranged on the elastic transmission element in order to measure the mechanical stress on the transmission element. The torque acting on the elastic transmission element is then determined from the mechanical stress. Typically, strain gauge assemblies are used with multiple strain gauges arranged, for example, in a bridge circuit. If a strain gauge assembly only covers a limited angular range of the transmission element, the measurement signal depends on the angular position of the wave generator. However, if the strain gauge assembly extends over the entire or almost the entire circumference of the transmission element, a measurement signal can be obtained which is not based on the angular position of the wave generator or is only based on the angular position of the wave generator to a small extent.

In order to detect faulty strain gauges of a strain gauge assembly, WO 2021/148068 A1 discloses a method for checking an assembly of strain gauges which makes it possible to detect a single defect in one of multiple strain gauges. The method uses a predictive model determined by finite element analysis or machine learning and therefore requires considerable computing power.

### SUMMARY

Against this background, the object is to provide a method and a system that increases functional safety by identifying a failure or faulty function of a measurement channel of a strain gauge assembly, while reducing the computing power required to detect such a defect.

The object is achieved by a method for detecting a faulty measurement channel on an elastic transmission element in a strain wave gearing mechanism, wherein a wave generator acts on the elastic transmission element, wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator to a small extent, and wherein the elastic transmission element has a second strain gauge assembly with multiple second measurement channels, wherein second measurement signals of the individual second measurement channels of the second strain gauge assembly are based on the rotational position of the wave generator, wherein for each measurement channel of the second measurement channels, a plausibility check is carried out using the first measurement signal and one or more of the second measurement signals.

The method according to the disclosure makes use of an elastic transmission element comprising two strain gauge assemblies. The second strain gauge assembly has multiple second measurement channels, each of which supplies second measurement signals that are based on the rotational position of the wave generator. By linking these second measurement signals, an output signal can be obtained which does not exhibit this dependency and is proportional to the torque. This output signal can have a high degree of accuracy and can be used to measure the torque during operation of the transmission element. The first strain gauge assembly, on the other hand, comprises only a first measurement channel, the first measurement signal of which is not based on the angular position of the wave generator or is only based on the angular position of the wave generator to a small extent. The method according to the disclosure makes it possible to detect faulty second measurement channels by carrying out a plausibility check for each of the second measurement channels on the basis of the first measurement signal and one or more second measurement signals.

A measurement channel of a strain gauge assembly can have one or more strain gauges. The strain gauges measure the mechanical stress in the elastic transmission element, wherein the mechanical stress is proportional to the present torque. A faulty measurement channel can occur in particular if a strain gauge is damaged. Preferably, each first and each second measurement channel comprises multiple strain gages which are connected in a bridge circuit, in particular a Wheatstone measuring bridge.

The first strain gauge assembly has a first measurement channel, wherein its first measurement signal is not based on the angular position of the wave generator or is only based on the angular position of the wave generator to a small extent. The first strain gauge assembly can extend around the entire or almost the entire circumference of the elastic transmission element. The first strain gauge assembly can be arranged on a lateral surface (parallel to the axis of rotation of the transmission element) or an end face (perpendicular to the axis of rotation of the transmission element) of the elastic transmission element.

The second strain gauge assembly can be arranged on a lateral surface (parallel to the axis of rotation of the transmission element) or an end face (perpendicular to the axis of rotation of the transmission element) of the elastic transmission element. Preferably, the first and second strain gauge assemblies are arranged together on the lateral surface or together on the end face. The strain gauges of the multiple second measurement channels of the second strain gauge assembly are preferably arranged in such a way that two second measurement signals each provide an almost identical value. The redundancy of the measurement signals can further increase the integrity of the strain wave gearing mechanism. The torque is determined from the measurement signals and the measured mechanical stresses, wherein the determined torque from the second measurement channels is based on the angular position of the wave generator. The second strain gauge assembly can, for example, have two, four or eight measurement channels, wherein the second strain gauge assembly particularly preferably has four measurement channels.

According to a preferred embodiment, a difference between a first term dependent on the first measurement signal and a second term dependent on multiple second measurement signals is formed for the plausibility check. It is therefore possible to identify whether a measurement channel is faulty by comparing the first term and the second term. This simple calculation has a particularly beneficial effect on the required computing power.

The first and/or the second term preferably comprises one or more proportionality factor(s) and/or one or more constant(s), which are preferably determined empirically. These proportionality factors and constants can be determined from experimental data or from simulation data or by calibration. For plausibility checks, the absolute value of the difference can be calculated and compared with a tolerance value. This tolerance value can be determined empirically or by simulation, and the tolerance value can be selected identically for all measurement channels or can be determined individually for each measurement channel. Furthermore, the tolerance value can have a fixed value or be adjusted as the operating period progresses.

According to a preferred embodiment, a plausibility check of the first measurement channel is carried out in a validation step preceding the plausibility check of the second measurement channels. The plausibility check of the first measurement channel can thereby increase the integrity of the plausibility check of the second measurement channels.

According to a preferred embodiment, the plausibility check of the first measurement channel is carried out on the basis of predetermined parameters of the strain wave gearing mechanism and an input torque value transmitted by a motor control unit of an electric motor connected to the strain wave gearing mechanism. Preferably, the predetermined parameter of the strain wave gearing mechanism is determined from the transmission ratio of the transmission and the transmission efficiency.

The plausibility is advantageously formed from the absolute value of the difference between the first term and a third term, wherein the third term is determined from the predetermined parameter of the strain wave gearing mechanism and the input torque value transmitted by a motor control unit of an electric motor connected to the strain wave gearing mechanism. The absolute value of the difference can be compared with a tolerance value.

According to a preferred embodiment, the input torque value is determined on the basis of a measured electric current and/or on the basis of control signals from the motor control unit. The measured electric current can be used to determine the torque present on the input side without the use of an additional strain gauge. Additionally or alternatively, the torque present on the input side can also be determined from the available control signals for controlling an electric motor. The omission of an additional strain gauge eliminates a potential source of error.

According to an alternative, preferred embodiment, the plausibility check of the first measurement channel is carried out on the basis of predetermined parameters of the strain wave gearing mechanism and a sensor torque value transmitted by a further torque sensor. The further torque sensor can be arranged on the input or output side of the strain wave gearing mechanism.

A further object of the disclosure is a method for determining a torque acting on an elastic transmission element of a strain wave gearing mechanism, wherein a wave generator acts on the elastic transmission element, wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator to a small extent, and wherein the elastic transmission element has a second strain gauge assembly with multiple second measurement channels, wherein second measurement signals of the individual second measurement channels of the second strain gauge assembly are based on the rotational position of the wave generator, wherein a faulty second measurement channel is detected according to a method according to an embodiment of the present disclosure, the faulty second measurement channel is corrected on the basis of the first measurement signal and one or more second measurement signals, and wherein the torque acting on the transmission ring is determined on the basis of the corrected second measurement channel and the remaining second measurement channels.

Detecting a faulty second measurement channel according to the disclosure makes it possible to correct the second measurement channel recognized as faulty. In order to correct the faulty second measurement channel, a substitute signal can be determined which is based on the first measurement signal and one or more of the other second measurement signals. In addition, the corrected second measurement channel can be included when determining the torque acting on the transmission ring. The advantage is that a faulty channel can be corrected or replaced so that this channel further increases the integrity of the measured torque on the strain wave gearing mechanism.

Preferably, only the first measurement signal and exactly one second measurement signal are required to correct the measurement channel recognized as faulty. This does not require a computationally intensive prediction model. Preferably, the first measurement signal and a second measurement signal are each multiplied by a proportionality factor and/or a constant is added thereto.

A further object of the disclosure is a drive module with a strain wave gearing mechanism, having an elastic transmission element and a wave generator acting on the elastic transmission element, wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator to a small extent, and wherein the elastic transmission element has a second strain gauge assembly with multiple second measurement channels, wherein second measurement signals of the individual second measurement channels of the second strain gauge assembly are based on the rotational position of the wave generator, and with an evaluation unit which is configured to detect a faulty second measurement channel according to a method according to an embodiment of the present disclosure, to correct the faulty second measurement channel on the basis of the first measurement signal and one or more second measurement signals, and to determine the torque acting on the transmission ring on the basis of the corrected second measurement channel and the remaining second measurement channels.

The drive module can achieve the same advantages and effects that have already been described in connection with the method according to the disclosure for detecting a faulty measurement channel.

According to a preferred embodiment, the drive module has an electric motor and a motor control unit, wherein the evaluation unit is further configured to perform a plausibility check of the first measurement channel in a validation step preceding the plausibility check of the second measurement channels, wherein the plausibility check of the first measurement channel is carried out on the basis of predetermined parameters of the strain wave gearing mechanism and an input torque value transmitted by a motor control unit of an electric motor connected to the strain wave gearing mechanism.

Alternatively or additionally, the advantageous embodiments and features described in connection with the method for detecting a faulty measurement channel according to the disclosure can also be applied to the drive module, alone or in combination.

The disclosure further relates to a robot arm having at least one drivable arm segment, wherein the arm segment can be driven via the drive module according to one of the preceding embodiments of the disclosure.

The robot arm can achieve the same advantages and effects that have already been described in connection with the method for detecting a faulty measurement channel according to the disclosure. The advantageous embodiments and features described in connection with the method for detecting a faulty measurement channel according to the invention disclosure can also be applied to the robot arm, alone or in combination.

### BRIEF DESCRIPTION OF THE DRAWINGS

Further details and advantages of the disclosure are explained below with reference to the exemplary embodiment shown in the drawings. In the drawings:

FIG. 1 shows an exemplary embodiment of an elastic transmission element with a first and a second strain gauge assembly;

FIG. 2 shows a schematic representation of a preferred circuitry of strain gauges of a measurement channel;

FIG. 3 shows multiple measurement signals from different second measurement channels;

FIG. 4 shows a schematic flow diagram of an exemplary embodiment of the method according to the disclosure;

FIG. 5 shows an exemplary embodiment of a robot in a schematic representation.

### DETAILED DESCRIPTION

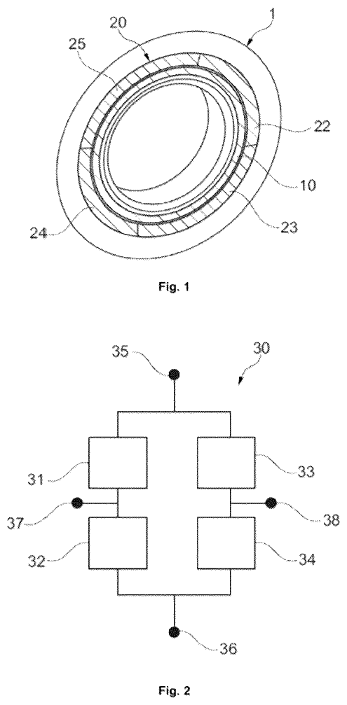

FIG. 1 shows an elastic transmission element 1, wherein the elastic transmission element 1 has a first strain gauge assembly 10 and a second strain gauge assembly 20. The elastic transmission element 1 can be used as part of a strain wave gearing mechanism. The strain wave gearing mechanism can have a wave generator, a rigid outer ring having an internal toothing system and the elastic transmission element 1 arranged therebetween.

In the exemplary embodiment, the two strain gauge assemblies are arranged on an end face of the transmission element 1, which is arranged perpendicular to an axis of rotation of the transmission element 1. The first strain gauge assembly 10 extends completely over the circumference of the transmission element, i.e., it completely covers the angular area around the axis of rotation. The second strain gauge assembly 20 comprises multiple, here four, second measurement channels 22, 23, 24, 25. In the exemplary embodiment, the second strain gauge assembly 20 is arranged radially outside of the first strain gauge assembly 10. According to a modification of this exemplary embodiment, the strain gauge assembly 20 can be arranged radially inside of the first strain gauge assembly 10.

The first measurement channel and the second measurement channels 22, 23, 24, 25 each have multiple strain gauges. As a result of mechanical load, the strain gauges are deformed and their electrical resistance changes. This change in resistance can be detected and from this the mechanical stress in the elastic transmission element 1 and the torque acting on the transmission element 1 can be derived.

FIG. 2 shows an exemplary schematic representation of a preferred circuitry 30 of the strain gauges of a measurement channel as a Wheatstone bridge. This circuitry is preferably used for the first measurement channel and the second measurement channels 22, 23, 24, 25.

The bridge circuit shown in FIG. 2 comprises four strain gauges 31, 32, 33, 34. Two of these strain gauges 31, 32, 33, 34 are each connected in series to form one branch of the bridge circuit. The bridge circuit comprises two branches connected in parallel. A supply voltage is applied to the branches between a supply voltage terminal 35 and a ground terminal 36. A tap 37, 38 is provided between the two strain gauges of each branch and is used to tap the measurement signal of the respective measurement channel.

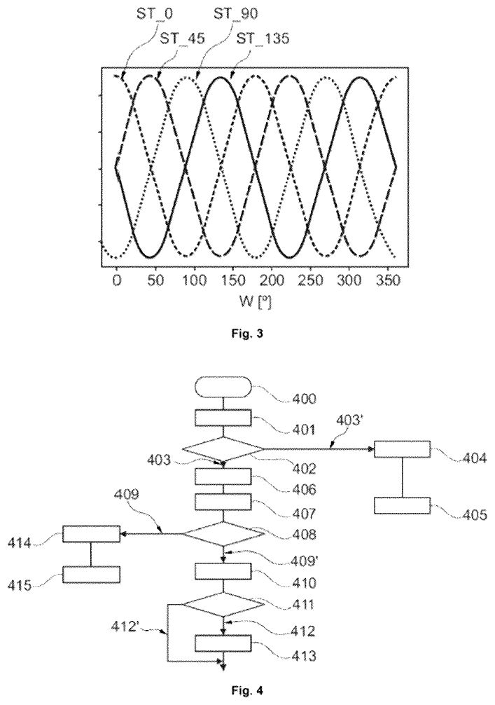

FIG. 3 shows second measurement signals ST_0, ST_45, ST_90, ST_135 of the second measurement channels 22, 23, 24, 25. It can be seen that the second measurement signals ST_0, ST_45, ST_90, ST_135 have a sinusoidal course on the basis of the rotational position W of the wave generator. In this regard, the second measurement channels 22, 23, 24, 25 are arranged in such a way that the second measurement signals ST_0, ST_45, ST_90, ST_135 each have a phase offset of 45° relative to one another. Two of the second measurement signals are symmetrical in each case (e.g., measurement signals ST_0 and ST_90 as well as ST_45 and ST_135) so that their oscillations cancel each other out when added. The sum of all four measurement signals ST_0, ST_45, ST_90, ST_135 is proportional to the torque on the elastic transmission element 1. The torque can thus be calculated by multiplying the sum of all four measurement signals ST_0, ST_45, ST_90, ST_135 by a predetermined proportionality factor (e2).

$${T}_{Ges} = e 2 * ( ST\_ 0 + ST\_ 45 + ST\_ 90 + ST\_ 135 )$$

In a preferred embodiment, each measurement signal ST_0, ST_45, ST_90, ST_135 has a proportionality factor and/or a constant. It is conceivable in this regard that the factors and constants will be adjusted as the operating period progresses.

However, a torque present at a second measurement channel can be determined on the basis of the measurement signals from two measurement channels, each offset by 180°. For example, the following torque values T_0, T_45, T90 and T135 result:

$$T\_ 0 = a 1 * ST\_ 0 + a 2 * ST\_ 90 + b 1$$

$$T\_ 45 = a 3 * ST\_ 45 + a 4 * ST\_ 135 + b 2$$

$$T\_ 90 = a 5 * ST\_ 90 + a 6 * ST\_ 0 + b 3$$

$$T\_ 135 = a {7}^{⋆} ST\_ 135 + a 8 * ST\_ 45 + b 4$$

The first measurement signal ST_circular of the first measurement channel of the first strain gauge assembly 10, on the other hand, is not based on the angular position of the wave generator or is only based on the angular position of the wave generator to a small extent.

Alternatively, the torque values can be determined from the symmetrical second measurement signals ST_0, ST_45, ST_90, ST_135 and the first measurement signal ST_circular:

$$ST\_ 90 \_hat = c 1 * ST\_ 0 + c 2 * ST\_circular + d 1$$

$$ST\_ 135 \_hat = c 3 * ST\_ 45 + c 4 * ST\_circular + d 2$$

$$ST\_ 0 \_hat = c 5 * ST\_ 90 + c 6 * ST\_circular + d 3$$

$$ST\_ 45 \_hat = c 7 * ST\_ 135 + c 8 * ST\_circular + d 4$$

Here, a1 to a7, b1 to b4 and c1 to c8 are predetermined values that were determined, for example, as part of a calibration.

Provided that the first measurement channel is functional, torque values can be specified on the basis of the above equations when ST_90_hat is inserted for ST_90 and so on, which are, in each case, based on a second measurement channel and the first measurement channel only:

$$T\_ 0 = a 1 * ST\_ 0 + a 2 * ( c 1 * ST\_ 0 + c 2 * ST\_circular + d 1 ) + b 1$$

$$T\_ 45 = a 3 * ST\_ 45 + a 4 * ( c 3 * ST\_ 45 + c 4 * ST\_circular + d 2 ) + b 2$$

$$T\_ 90 = a 5 * ST\_ 90 + a 6 * ( c 5 * ST\_ 90 + c 6 * ST\_circular + d 3 ) + b 3$$

$$T\_ 135 = a 7 * ST\_ 135 + a 8 * ( c 7 * ST\_ 135 + c 8 * ST\_circular + d 4 ) + b 4$$

FIG. 4 shows a flow diagram of an exemplary embodiment of a method 400 for detecting and correcting a faulty measurement channel. In a first method step 401, the plausibility of the measurement signal of the first measurement channel is checked as part of a plausibility check. In this step, the extent to which the determined torque of the first measurement channel differs from the present torque is validated. For this purpose, the torque present at the elastic transmission element 1 can be determined on the basis of predetermined parameters of the strain wave gearing mechanism and an input torque value transmitted by a motor control unit of an electric motor connected to the strain wave gearing mechanism. In this context, the motor control unit can transmit the input torque value and/or other parameters to an evaluation unit, for example using the SPI (serial peripheral interface) protocol. The input torque value can be determined on the basis of a measured electric current and/or on the basis of control signals from the motor control unit. Alternatively, the first measurement channel can be validated via a further torque sensor, which is arranged on the input or output side of the strain wave gearing mechanism.

In a first comparison step 402, it is determined whether the measured torque value of the first measurement channel is within a predetermined tolerance range. If the measured torque value is outside of this tolerance range (arrow 403′), an error state 404 of the first measurement channel is present. In a notification step 405, an error message is generated and transmitted, for example, to the motor control unit.

If the measured torque value is within the predetermined tolerance range (arrow 403), the first measurement channel is in a functional operating state 406. The first measurement channel can therefore be used to subsequently check the plausibility of the second measurement signals ST_0, ST_45, ST_90, ST_135 of the second measurement channels 22, 23, 24, 25 in a checking step 407.

In this checking step 407, a difference is formed for each second measurement signal from the product of the first measurement signal ST_circular with a predetermined proportionality factor e1 and the respective torque value T_0, T_45, T_90, T_135, which is dependent only on a second measurement signal and the first measurement signal ST_circular.

If abs (e1*ST_circular−T_0)>tolerance value_0, the second measurement channel 22 associated with the second measurement signal ST_0 is faulty. If abs (e1*ST_circular−T_45)>tolerance value_45, the second measurement channel 23 associated with the second measurement signal ST_45 is faulty. If abs (e1*ST_circular−T_90)>tolerance value_90, the second measurement channel 24 associated with the second measurement signal ST_90 is faulty. If abs (e1*ST_circular−T_135)>tolerance value_135, the second measurement channel 25 associated with the second measurement signal ST_135 is faulty.

The tolerance values_0, 45, 90, 135 can be identical or differ. This also includes the variant in which the tolerance values_0, 90 are identical and the tolerance values_45, 135 are identical, but the tolerance value_0, 90 and tolerance value_45, 135 differ.

First, a method step 408 checks whether all second measurement channels 22, 23, 24, 25 are faulty. If this is the case (arrow 409), a state 414 with four defective second measurement channels 22, 23, 24, 25 is present. In a notification step 415, an error message is generated and, if necessary, transmitted to the motor control unit. Error correction is not possible.

Unless all of the second measurement channels 22, 23, 24, 25 are defective (arrow 409′), error registers are set for the respective defective measurement channels 22, 23, 24, 25 in step 410. Subsequently, in step 411, it is checked whether only a single second measurement channel 22, 23, 24, 25 is defective. If such a single error of a second measurement channel 22, 23, 24, 25 is present (arrow 412), the respective faulty second measurement channel 22, 23, 24, 25 is corrected. The respective equation with the index_hat is used for the correction. For example, the measurement signal ST_0 is replaced by ST_0_hat for correction, the measurement signal ST_45 by ST_45_hat and so on. The correction is thus made on the basis of the first measurement signal ST_circular and a second measurement signal.

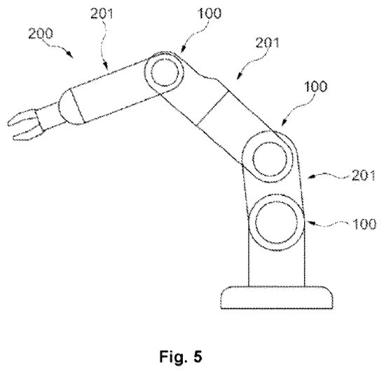

FIG. 5 shows, in a schematic representation, an exemplary embodiment of a robot designed as an industrial robot 200 with multiple arm segments 201, each rotatably connected via drive modules 100, with which the invention disclosure is implemented. Even though the industrial robot 200 shown here has three arm segments 201 and three drive modules 100, embodiments of the industrial robot 200 are conceivable with a different number of arm segments 201 and drive modules 100, for example four, five, six or seven. Furthermore, a drive module 100 can be used for any robot joints. Such industrial robots 200 are often used as collaborative robots that work in close cooperation with humans.

1. A method for detecting a faulty measurement channel on an elastic transmission element in a strain wave gearing mechanism, the method comprising:
acting on the elastic transmission element with a wave generator,
wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator to a small extent,
wherein the elastic transmission element has a second strain gauge assembly with multiple second measurement channels, wherein second measurement signals of the individual second measurement channels of the second strain gauge assembly are based on the rotational position of the wave generator; and
performing a plausibility check, for each measurement channel of the second measurement channels, using the first measurement signal and one or more of the second measurement signals.

2. The method according to claim 1, wherein a difference between a first term dependent on the first measurement signal and a second term dependent on multiple second measurement signals is formed for the plausibility check.

3. The method according to claim 1, wherein a plausibility check of the first measurement channel is carried out in a validation step preceding the plausibility check of the second measurement channels.

4. The method according to claim 3, wherein the plausibility check of the first measurement channel is carried out on the basis of predetermined parameters of the strain wave gearing mechanism and an input torque value transmitted by a motor control unit of an electric motor connected to the strain wave gearing mechanism.

5. The method according to claim 4, wherein the input torque value is determined on the basis of a measured electric current and/or on the basis of control signals from the motor control unit.

6. A method for determining a torque acting on an elastic transmission element of a strain wave gearing mechanism, the method comprising:
acting on the elastic transmission element with a wave generator,
wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator to a small extent, and
wherein the elastic transmission element has a second strain gauge assembly with multiple second measurement channels, wherein second measurement signals of the individual second measurement channels of the second strain gauge assembly are based on the rotational position of the wave generator,
wherein a faulty second measurement channel is detected according to a method according to claim 1, the faulty second measurement channel is corrected on the basis of the first measurement signal and one or more second measurement signals; and
determining a torque acting on the transmission ring based on the corrected second measurement channel and the remaining second measurement channels.

7. A drive module comprising:
a strain wave gearing mechanism including an elastic transmission element and a wave generator acting on the elastic transmission element,
wherein the elastic transmission element has a first strain gauge assembly with a first measurement channel, wherein a first measurement signal of the first measurement channel of the first strain gauge assembly is proportional to the torque and is not based on the angular position of the wave generator or is only based on the angular position of the wave generator a to small extent, and
wherein the elastic transmission element has a second strain gauge assembly with multiple second measurement channels, wherein second measurement signals of the individual second measurement channels of the second strain gauge assembly are based on the rotational position of the wave generator; and
an evaluation unit which is configured to
detect a faulty second measurement channel according to the method of claim 1, to correct the faulty second measurement channel on the basis of the first measurement signal and one or more second measurement signals, and
determine the torque acting on the transmission ring on the basis of the corrected second measurement channel and the remaining second measurement channels.

8. The drive module according to claim 7, wherein the drive module has an electric motor and a motor control unit, wherein the evaluation unit is further configured to perform a plausibility check of the first measurement channel in a validation step preceding the plausibility check of the second measurement channels, wherein the plausibility check of the first measurement channel is carried out on the basis of predetermined parameters of the strain wave gearing mechanism and an input torque value transmitted by a motor control unit of an electric motor connected to the strain wave gearing mechanism.

9. A robot arm having at least one drivable arm segment, wherein the arm segment is drivable via the drive module according to claim 8.

10. A method for detecting a faulty measurement channel on an elastic transmission element in a strain wave gearing mechanism, the method comprising:
acting on the elastic transmission element with a wave generator, wherein the elastic transmission element comprises a first strain gauge assembly with a first measurement channel and a second strain gauge with multiple second measurement channels, wherein the first measurement signal of the first measurement channel of the first strain gauge assembly is proportional to torque, wherein second measurement signals of the individual second measurement channels of the second strain gauge assembly are based on the rotational position of the wave generator; and
performing a plausibility check, for each measurement channel of the second measurement channels, using the first measurement signal and one or more of the second measurement signals,
wherein a difference between a first term dependent on the first measurement signal and a second term dependent on multiple second measurement signals is formed for the plausibility check
wherein a plausibility check of the first measurement channel is carried out in a validation step preceding the plausibility check of the second measurement channels.

11. The method according to claim 1, wherein the plausibility check of the first measurement channel is carried out on the basis of predetermined parameters of the strain wave gearing mechanism and an input torque value transmitted by a motor control unit of an electric motor connected to the strain wave gearing mechanism.

12. The method according to claim 11, wherein the input torque value is determined on the basis of a measured electric current and/or on the basis of control signals from the motor control unit.

13. A drive module comprising:
a strain wave gearing mechanism comprising:
an elastic transmission element; and
a wave generator acting on the elastic transmission element,
wherein the elastic transmission element has a first strain gauge assembly with a first measurement channel, wherein a first measurement signal of the first measurement channel of the first strain gauge assembly is proportional to the torque, wherein the elastic transmission element has a second strain gauge assembly with multiple second measurement channels, wherein second measurement signals of the individual second measurement channels of the second strain gauge assembly are based on the rotational position of the wave generator; and
an evaluation unit configured to:
detect a faulty second measurement channel by performing a plausibility check for each measurement channel of the second measurement channels using the first measurement signal and one or more of the second measurement signals;
correct the faulty second measurement channel on the basis of the first measurement signal and one or more second measurement signals; and
determine the torque acting on the transmission ring on the basis of the corrected second measurement channel and the remaining second measurement channels.

14. The drive module according to claim 13, wherein a difference between a first term dependent on the first measurement signal and a second term dependent on multiple second measurement signals is formed for the plausibility check.

15. The drive module according to claim 13, wherein a plausibility check of the first measurement channel is carried out in a validation step preceding the plausibility check of the second measurement channels.

16. The drive module according to claim 13, wherein the plausibility check of the first measurement channel is carried out on the basis of predetermined parameters of the strain wave gearing mechanism and an input torque value transmitted by a motor control unit of an electric motor connected to the strain wave gearing mechanism.

17. The drive module according to claim 16, wherein the input torque value is determined on the basis of a measured electric current and/or on the basis of control signals from the motor control unit.
